(19) United States
(12) Patent Application Publication
(10) Pub. No.: US 2008/0126155 A1
(43) Pub. Date: May 29, 2008

(54) Method and apparatus for enterprise operation assessment

(75) Inventors: Tian Xu, Shanghai (CN); Fangning Chen, Shanghai (CN); Tianyang Wang, Shanghai (CN)

Correspondence Address: SAP/BLAKELY, 1279 OAKMEAD PARKWAY, SUNNYVALE, CA, 94085-4040, US

(73) Assignee: SAP AG

(21) Appl. No.: 11/605,805

(22) Filed: Nov. 27, 2006

(51) Int. Cl. G06Q 10/00

(52) U.S. Cl. 705/7

(57) ABSTRACT

A method and an apparatus for automatic generation of an enterprise operation health assessment of an organization by dynamically accessing an associated enterprise information system are described. The assessment may be initiated in response to a query over a network. Business transaction information during course of operations within the organization may be retrieved according to one or more requirements of the enterprise operation health assessment report based on the received query. In addition, an advisory report may be generated based on the enterprise operation health assessment report according to one or more rules.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention relates generally to enterprise computing. More particularly, this invention relates to real-time credit report for assessing enterprise operation health.

### BACKGROUND

Many enterprise business activities require timely credit information to complete a transaction. Such credit requirement occurs, for example, when an enterprise applies for a loan from a bank or when an enterprise attempts to provide its potential business partners a credit proof. Credit information is often presented in a credit report. A vast variety of business aspects may affect the result of a credit report, such as total asset, total debt, annual revenue, profit margin, market size, growth rate etc. associated with the enterprise.

Usually, a group of auditors or credit agents are involved in creating a credit report by compiling an assessment of the underlying organization and its business. Often times, credit related data is manually collected and verified from the enterprise. A credit analysis is then conducted based on the collected data to produce a credit report. It is not unusual to take several days, even weeks, to produce an up to date report for assessing enterprise operation health.

However, such a manual assessment process may not be comprehensive and effective enough for today's fast paced enterprise business. For example, daily business transactions may include business information too fragmented to be manually collected. Certain business transactions may be missed as they continually occur at the same time when a credit report is being manually prepared. Furthermore, most conventional credit reports focus only on passive credit information without pointing out actionable items for improving future credit status. As a result, the manual assessment process is not only costly and time consuming, the resulting report might not accurately reflect a thorough coverage over the need for timely credit information and advices.

### SUMMARY OF THE DESCRIPTION

The present invention includes a method and apparatus that automatically generates an enterprise operation health (EOH) assessment of an organization by dynamically accessing an associated enterprise information system. The assessment may be initiated in response to a query over a network. Business transaction information during course of operations within the organization may be retrieved according to one or more requirements of the EOH report based on the received query. In addition, an advisory report may be generated based on the enterprise operation health assessment report according to one or more rules.

Other features of the present invention will be apparent from the accompanying drawings and from the detailed description that follows.

### DESCRIPTION OF THE DRAWINGS

The present invention is illustrated by way of example and not limitation in the figures of the accompanying drawings, in which like references indicate similar elements and in which:

FIG. 1 is a block diagram illustrating one embodiment of a system for accessing enterprise operation health.

FIG. 2 is a flow diagram illustrating one embodiment of a process for accessing enterprise operation health in accordance with the system of FIG. 1.

FIG. 3 is a block diagram illustrating one embodiment of a system for accessing data for assessing enterprise operation health.

FIG. 4 is a block diagram illustrating one embodiment of a system for selectively collecting data for accessing enterprise operation health.

FIG. 5 is a block diagram illustrating an embodiment of a system for selecting key performance indicators for accessing enterprise operation health.

FIG. 6 is an example of user interface illustrating a credit report according to one embodiment of accessing enterprise operation health.

FIG. 7 illustrates one example of a computer system which may be used with one embodiment of the present invention.

### DETAILED DESCRIPTION

A method and an apparatus for enterprise operation assessment are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, may be performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, assessing enterprise operation health provides a real-time service for generating a credit report on the associated enterprise entity. The report may include credit performances and credit improvement advices. A bank, a credit assessment organization or a business partner may utilize the report to measure a credit or business risk with respect to the underlying enterprise entity. Management team may rely on a credit report to take business actions for improving its future credit status. A credit report may be generated in real-time to reflect the current credit status of an enterprise in a timely manner. Additionally, business factors considered in a credit report may include daily business transactions to be comprehensive and accurate.

For example, credit data may be collected directly from an enterprise resource management system such as SAP business application, in a systematic manner without relying on third party credit collection or manual work. A Real Time EOH Assessment Controller may be utilized to provide such a service in an enterprise resource planning system. Note that throughout this application, for the illustration purposes only, an SAP business management system is used as an example to illustrate techniques of embodiments of the invention. However, it is not so limited. It will be appreciated that other management systems may also be applied.

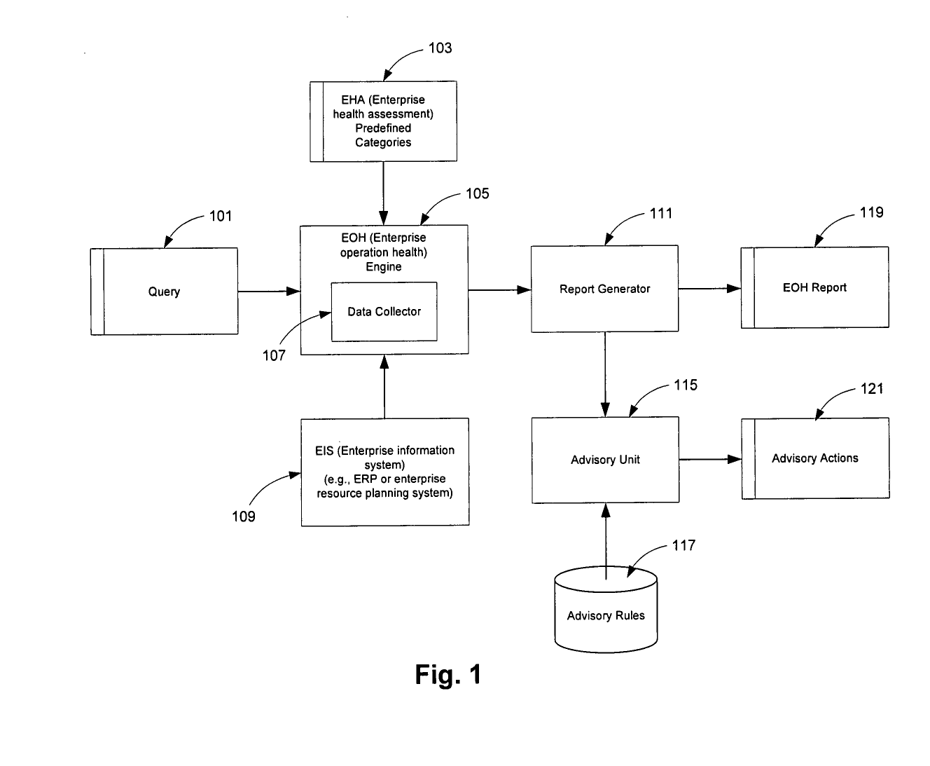

FIG. 1 is a block diagram illustrating one embodiment of a system for accessing enterprise operation health. According to certain embodiments of the invention, a real time assessment controller, is used to extract the enterprise credit related data as well as business transactions from an enterprise application (e.g., an EIS or ERP system). In one embodiment, the system can generate real time enterprise operations health assessment report, a credit performance oriented based on enterprise health assessment structure (e.g., business base, business operation, business environment), which can be used by bank for credit assessment, by credit assessment organization or for credit reference to business partners.

Accordingly, the techniques described through this application can provide real time credit information which is associated with a particular enterprise entity. In addition, a complete credit data/report covers a 360° view of the business and the daily business transactions, which brings less risk for a shareholder to detect firsthand update information. Further, less effort may be involved to prepare the raw data for creating a credit report generator and lowest TCO may be used to prepare such a credit report.

In one embodiment, referring to FIG. 1, an EOH engine 105 receives a query 101 for a status report on the associated business organization. The query 101 may originate from an application client coupled to EOH engine 105 over a network remotely or locally. The EOH engine 105 may be a part of an application server in an enterprise entity of the business organization. In one embodiment, the EOH engine 105 is coupled with an EIS (Enterprise Information System). An EIS may be an ERP (Enterprise Resource Planning) system associated with an enterprise entity. In one embodiment, EOH engine 105 includes a data collector 107. The data collector 107 may be a module configured to retrieve business transaction information from the EIS 109. The business transaction information may include real-time business transaction data associated with an enterprise entity. In one embodiment, data collector 107 is configured based on EHA (Enterprise Health Assessment) predefined categories 103. Each category may specify a set of business attributes related to business operations managed by EIS 109.

According to certain embodiments, data collector 107 can extract the enterprise credit related data as well as business transactions from an enterprise application (e.g., an EIS or ERP system). In one embodiment, when a user configures the EOH KPIs (key performance indexes) and relationships according to their enterprise health assessment requirement, which may come from banks, authorities, customers, suppliers or other business partners, the enterprise health assessment structure will transfer the eha requirements to data collector 107.

Then data collector 107 may store the configured EOH requirement into a mapping structure and then extract the related already existing KPI content from various business applications, such as SCM (supply chain management), FIN (financial), SRM (supplier relationship management), CRM (customer relationship management), PRO (project application), HR (human resources) also referred to HCM (human capital management), etc. into the mapping structure according to the predefined relationships or rules between an enterprise application (e.g., NetWeaver from SAP AG) build in KPIs and EOH KPIs. According to certain embodiments, enterprise applications have already predefined many KPIs and according to the business requirements for each industry. These KPIs may be calculated by the BI (business intelligence) unit, which may be a part of an information warehouse to analysis business data.

Referring back to FIG. 1, in response to receiving a query 101, according to one embodiment, data collector 107 retrieves business transaction information dynamically from EIS 109 based on the EHA predefined categories. The data collector 107 may collect business transaction information in real-time as described above. In one embodiment, EOH engine 105 forwards collected business transaction information to a report generator 111. Report generator 111 may be a module coupled with EOH engine 105 within a single application server or among multiple application servers (e.g., a server farm or a cluster of servers) associated with the enterprise entity. In one embodiment, report generator 111 performs data operations based on the collected business information to generate a credit report 119 according to the information requested by the query 101. The credit report 119 may include credit related information extracted or derived from the collected business information according the query 101. In one embodiment, report generator 111 forwards business transaction information to an advisory unit 115. The credit report 119 may be presented to a user through a user interface.

In one embodiment, advisory unit 115 is a module coupled with the report generator 111 within a single application server or among multiple application servers associated with the enterprise entity. The advisory unit 115 may derive a credit risk based on the information received from report generator 111. In one embodiment, advisory unit 115 creates an advisory action 121 according to the derived credit risk. In one embodiment, advisory unit 115 applies a set of predefined advisory rules 117 to generate advisory action 121. Advisory action 121 may include advices such as how to improve the credit status and what decisions to make. In one embodiment, advisory action 121 is presented to a user through a user interface. Note that some or all of the components as shown in FIG. 1 may be implemented in software, hardware, or a combination of both.

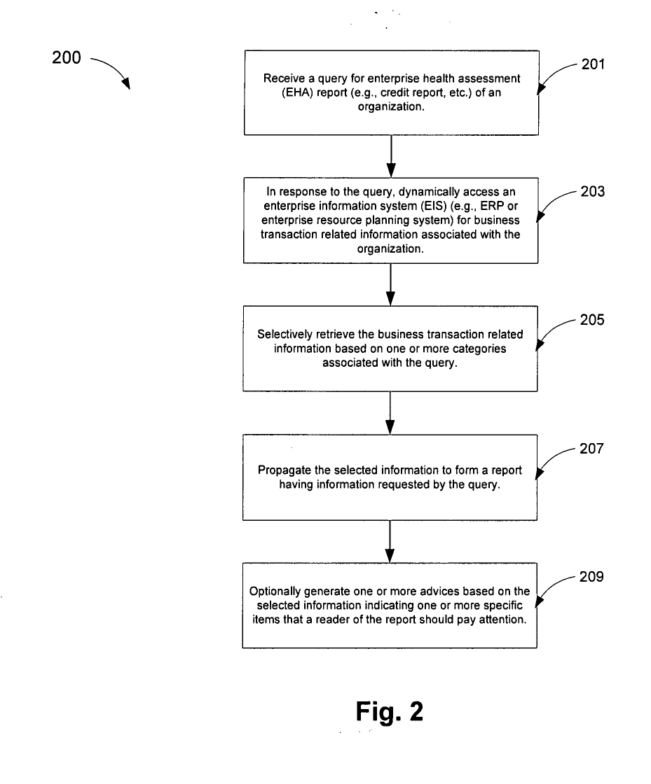

FIG. 2 a flow diagram illustrating one embodiment of a process for accessing enterprise operation health. The process 200 may be performed by a processing logic in a system as shown in FIG. 1. In one embodiment, the processing logic receives a query for the EHA report of an organization at block 201. The organization may be an enterprise entity. The query may include a scope. In one embodiment, the scope specifies a business unit of the organization. In one embodiment, the scope defines a type of the report, such as a report for a bank, a report for a business partner, a report for a customer, a report for a supplier or a report for an authority. The EHA report may be a credit report or other business reports. In one embodiment, a credit report includes histories of borrowing and repaying by an organization. In another embodiment, a credit report includes business transactions with customers, suppliers, banks, or business partners associated with an organization. A credit report may include business attributes, such as asset, debt, earnings, etc. associated with an organization. An EOH report 119 may include similar information as in an EHA report.

At block 203, according to one embodiment, the processing logic dynamically accesses an EIS for business related information associated with the organization in response to the query of block 201. The EIS may include an SAP ERP application, such as a FIN application, an SCM application, an application, a CRM application, or a PRO application. The business related information may include real-time business transaction information. A business transaction may be conducted between an enterprise and its customer, business partner, bank, or supplier.

In one embodiment, at block 205, the processing logic selectively retrieves the business related information from the EIS based on one or more categories associated with the query of block 201. In one embodiment, selecting which business information to retrieve is based on a set of predefined categories. A category may include one or more business attributes. A business attribute may correspond to a value provided by an EIS to characterize the business associated with the organization. For example, in one embodiment, business attributes include the annual revenue, the profit margin, the head count number, or number of years of data history associated with the organization. Business attributes in a category may be hierarchically structured. The report scope specified in a query at block 201 may determine which business attributes are included in retrieving the business related information. In one embodiment, an EHA report for a bank is based on a business attribute such as the cash flow. In one embodiment, an EHA report for an enterprise is independent of some business attribute such as the sickness rate.

At block 207, according to one embodiment, the processing logic forms a report having information requested by the query based on the selectively retrieved business related information propagated from the EIS. In one embodiment, the processing logic performs data operations based on the retrieved business related information to extract credit related data. The processing logic may derive credit information from the credit related data. Credit information may be a credit score calculated based on a mathematical formula. In one embodiment, the processing logic generates a credit report having a summary according to the credit information. In one embodiment, a credit report is based on the generic assessment rule published by union of commercial bank.

A credit report may include daily business transactions with business partners, customers, or suppliers. In one embodiment, the credit report includes borrowing and payment histories with lending institutions (such as banks), asset valuation, debt and/or credit, etc. In one embodiment, processing logic receives a user input to adjust the associated scope to dynamically generate EHA reports covering different scopes. The query of block 201 may include the default scope employed by the processing logic to generate an EHA report.

At block 209, according to one embodiment, processing logic optionally generates one or more advices based on the selected information. Each advice may correspond to a business item a user should pay attention to. A business item may be a business decision such as reducing the head count of the associated organization by a certain percentage. In one embodiment, processing logic evaluates a credit risk based on one or more formulae of the retrieved business attributes.

A business attribute may be a KPI. In one embodiment, the processing logic structures and derives risk assessment from the selected business information according to 4C (character, capacity, capital, and condition) structure from a well-known standard. The processing logic may generate a BTM (business task management) alert or notification in terms of the credit risk. BTM is an infrastructure to address business object related tasks to end users including automating workload distribution and workflow. BTM supports a variety of functionalities including, but are not limited to:
Integrated status and action management
Guidance for end users for their daily work, including assignment of tasks to responsible persons, and prioritization of work items
Collaboration between end users, including forward business objects and clarification
Work load distribution, including assignment of tasks to responsible users/groups/roles and end user may define rules for automatic forward
Escalation mechanisms, including time depended (deadline reached) and manual escalation
Process transparency, including tracking and monitoring

Referring back to FIG. 2, in one embodiment, processing logic provides credit advices, for example, in terms of credit risks. A credit advice may be related to business actions to improve the credit status of an organization. In one embodiment, a credit advice includes how to make business decisions without hurting the credit status of an organization. In one embodiment, an option to generate a credit advice is based on the query of block 201. In another embodiment, the option is determined dynamically according to a user input through a user interface. Other operations may also be performed.

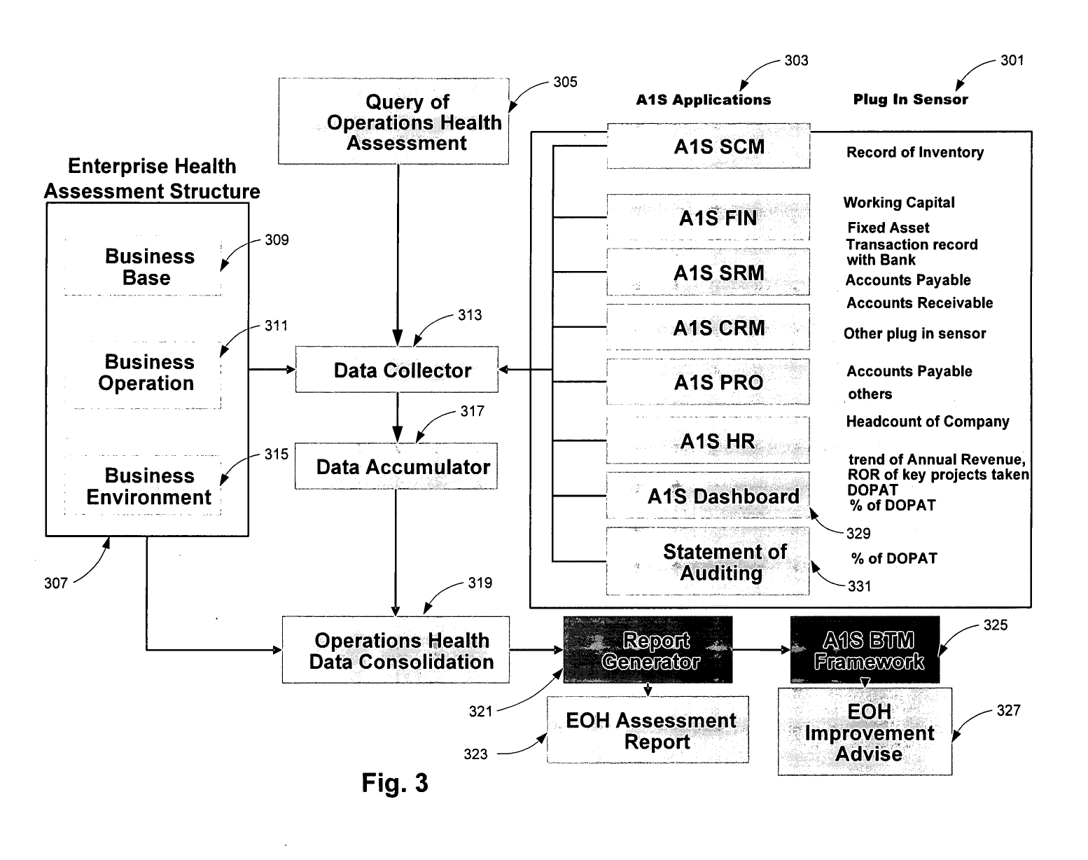

FIG. 3 is a block diagram illustrating one embodiment of a system for collecting data for assessing enterprise operation health. In one embodiment, a data collector 313 receives a query 305 for operations health assessment. For example, data collector 313 may be implemented as a part of data collector 107 of FIG. 1. In one embodiment, an enterprise health assessment structure 307 includes business attributes for the data collector 313 to retrieve business related information. Business attributes may include one or more categories, such as business base 309, business operation 311 and business environment 315.

A business base category 309 may include business attributes related to the base of running the business associated with an organization, such as the revenue, the profit margin, the headcount, and the number of years of data history. Business attributes in a business operation category 311 may be grouped according to their relevancies to, for example, cash, capital, material, business partner or people aspects of the associated organization. Cash relevant attributes may include cash flow, cash liquidity, debt, dunning, or identified default cash status. The identified default cash status attribute may have a binary value, for example, as either 1 (yes) or 0 (no). Capital relevant attributes may include total asset, available cash and liquidity, financial balance trend, working capital, or net worth capital. Material relevant attributes may include stock out of SCM, inventory, or cycle days. Business partner relevant attributes may include supplier on time delivery performance. People relevant attributes may include sickness rate. A business environment category 315 may include business attributes related to external factors surrounding the business associated with an organization, such as a measure of market fluctuations, index of key competitors, currency rates or company growth rate. In one embodiment, the enterprise assessment structure 307 is predefined.

In one embodiment, the data collector 313 dynamically retrieves business related information from an EIS based on the received query 305 and the business attributes from the enterprise assessment structure 307. An EIS may include SAP ERP applications 303. An EIS application may provide a value representing specific business related information through a plug in software, such as plug in sensors 301 for inventory record, working capital, or fixed asset etc. In one embodiment, business related information includes visual data from an EIS application such as dashboard 329.

A dashboard leverages enterprise data resources to deliver an easy to understand visual display of key performance indicators, presented with concise report and graphical formats. A dashboard incorporates transactional and operational data in one single view but provides a 360 degree view of a business. Using this actionable information, management can drill-down into details to investigate and explore further, when needed, to ensure an intelligent and timely business decision. Dashboards deliver enough data to get a picture of what is going on in a certain context and the ability to get more details if required. This provides decision makers with the right information, at the right time, in the right place, enabling them to make better business decisions. In addition, as follow up, organizations identify and develop proactive alerts via email or SMS when a particular key performance indicator falls outside the predetermined thresholds.

A visual data may be associated with business attributes in graphic formats. Business related information may be audited business attributes produced by an EIS application such as the statement of auditing 331 based on third party auditors. In one embodiment, business related information include benchmark data associated with business attributes. Benchmark data may be related to expected values of business attributes automatically derived by an EIS application according to histories of business performance. In one embodiment, benchmark data is based on well-known public consensus.

In one embodiment, the data collector 313 selects a subset of the business attributes in the enterprise health assessment structure 307 according to the scope associated with the query 305. The data collector 313 may retrieve business related information from the EIS 203 in accordance with the selected business attributes. In one embodiment, the data collector 313 retrieves business related information via an enterprise application platform such as SAP Netweaver.

In one embodiment, a data accumulator 317 processes business related information collected by the data collector 313 to derive additional credit related data. In one embodiment, data accumulator 317 may process the related data which were extracted from different applications and plug-in sensors according to an EOH mapping structure. After the processing, all EOH KPIs will get the status light according to benchmark comparing result. An additional credit related data may be a status according to a comparison between business attributes and associated benchmark information. A status may have a binary value to indicate whether the result of a benchmark comparison is satisfactory or not. The benchmark comparison may be based on a reference according to the benchmark. In one embodiment, the reference may have a value corresponding to the benchmark value adjusted by a tolerance range.

In one embodiment, the enterprise health assessment structure 307 includes manually input data such as values of business attributes, media coverage, stock performance. A user may provide a business related data to fine tune the result of the assessment. In one embodiment, an operation health data consolidation 319 consolidates manual input data with dynamically retrieved data, such as business related information retrieved via the data collector 313, into consolidated data to be stored in a database. Consolidated data may include the value of a business attribute derived from a combination of the corresponding manual input value in the enterprise health assessment structure 307 and the dynamically retrieved value via the data collector 313.

In one embodiment, data including automatically extracted data (e.g., situation data) and manually input data (e.g., appraisal data) can be consolidated in the data consolidation 319 and stored in a database. Then user can use report generator to generate the EOH report based on the detail information in data consolidation 319. Draft result from data accumulator 319 with status lights for each EOH KPIs may be consolidated here according to the EOH structure and high level status lights will be calculated in data consolidation 319.

In one embodiment, a manual input value has higher priority over a corresponding retrieved value from an EIS for the associated business attribute in deriving the consolidated data. In one embodiment, a business attribute may be assigned only a dynamically retrieved value or a manually input value. The operation health data consolidation may derive a high level status for a group of business attributes. A high level status may be a business base status associated with the business attributes organized under the business base category 309. In one embodiment, high level statuses include a business operation status corresponding to the business operation category 311 or a business environment status corresponding to the business environment category 315.

A report generator 321, according to one embodiment, extracts credit related data based on the consolidated data from an operation health data consolidation 319 to create an EOH assessment report 323. The report generator 321 may perform operations similar to those at block 207 of FIG. 2. In one embodiment, report generator 321 reads in the consolidated data from a database. In another embodiment, report generator 321 receives the consolidated data directly from the operation health data consolidation 319. An EOH assessment report 323 may include similar information as in an EOH report 119 of FIG. 1.

In one embodiment, an EOH assessment report 323 may be formatted based on the hierarchy organization of business attributes in the enterprise health assessment structure 307. The EOH assessment report 323 may include one or more levels of status information about business attributes provided by the data accumulator 317 and/or the operation health data consolidation 319. In one embodiment, a BTM framework 325 generates an EOH improvement advice 327 based on the consolidated data and/or the extracted credit related data from the report generator 321. The BTM framework may be, for example, part of SAP business management system. In one embodiment, a BTM framework performs operations similar to those at block 209 of FIG. 2. An EOH improvement advice may include similar information as in advisory actions 121 of FIG. 1. In one embodiment, BTM framework 325 sends out alerts and/or notifications according to advisory actions in the EOH improvement advice 327.

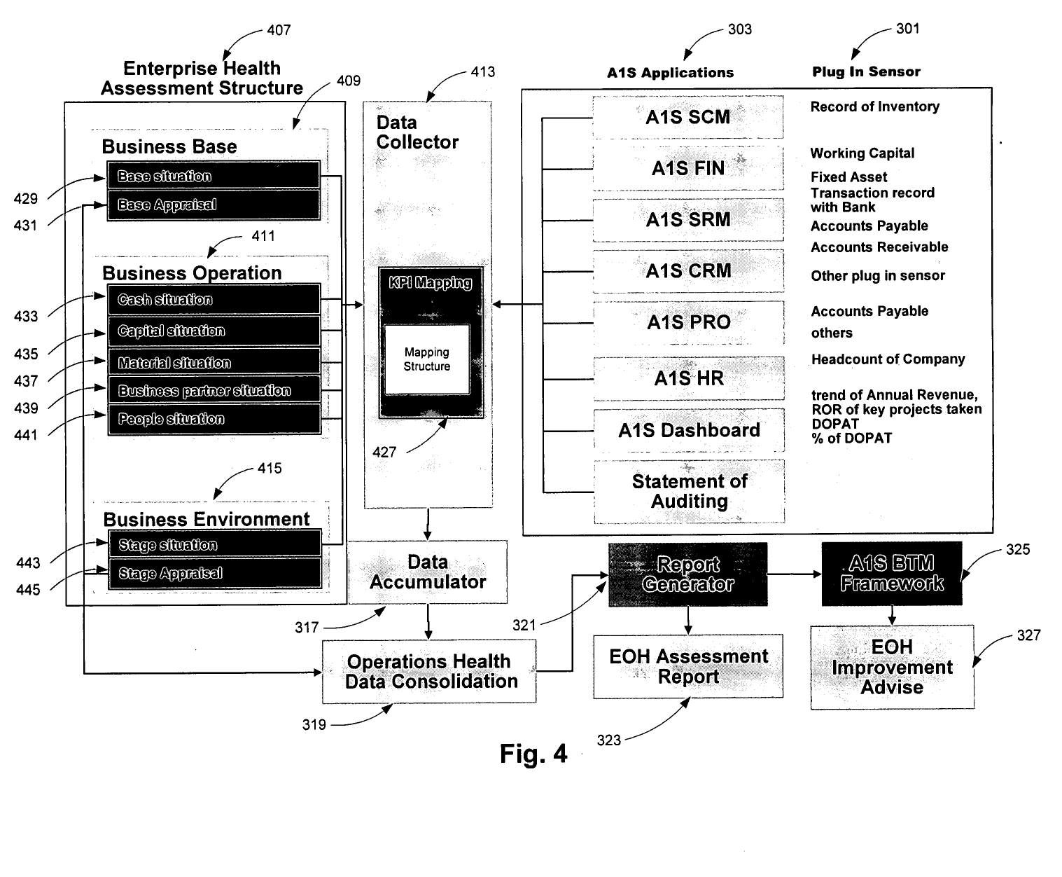

FIG. 4 is a block diagram illustrating an alternative embodiment of a system for selectively collecting data for accessing enterprise operation health. In one embodiment, an enterprise health assessment structure 407 includes a business base category 409 of business attributes related to the base of running a business. A business base category 409 may include groups of business attributes such as a base situation group 429 or a base appraisal group 431. The based situation group 429 may include business attributes similar to those in the business base category 309 of FIG. 3.

In one embodiment, values of business attributes in a base situation group 429 are collected from an ERP system. In one embodiment, values of business attributes in a base appraisal group 431 are predefined. An ERP system may provide a user interface for a user to enter relevant business attribute information including predefined business attribute values. A business attribute in a base appraisal group 431 may be an audit rating or a ratio of pure labor. In one embodiment, an enterprise health assessment structure 407 includes a business operation category 411. Similar to the business operation category 311 of FIG. 3, business attributes in a business operation category 411 may be grouped into a cash situation group 433, a capital situation group 435, a material situation group 437, a business partner situation group 439 and a people situation group 441.

In one embodiment, an enterprise health assessment structure 407 includes a business environment category 415 of business attributes related to external factors surrounding the business associated with an organization. A business environment category 415 may include a stage situation group 443 and a stage appraisal group 445 of business attributes. A stage situation group of business attributes may be similar to those included in the business environment category 315 of FIG. 3. A business attribute in a stage appraisal group 445 may be an industry growth rate. In one embodiment, values of business attributes in a stage appraisal group 445 are predefined.

The data collector 413, according to one embodiment, includes similar functionality of the data collector 313 of FIG. 3. A KPI (Key Performance Indicator) mapping 427 inside the data collector 413 may select a set of business attributes based on the scope of a query and the business attribute hierarchy in the enterprise health assessment structure 407. In one embodiment, the KPI mapping 427 is configurable to pre-select a subset of business attributes from the enterprise health assessment structure 407.

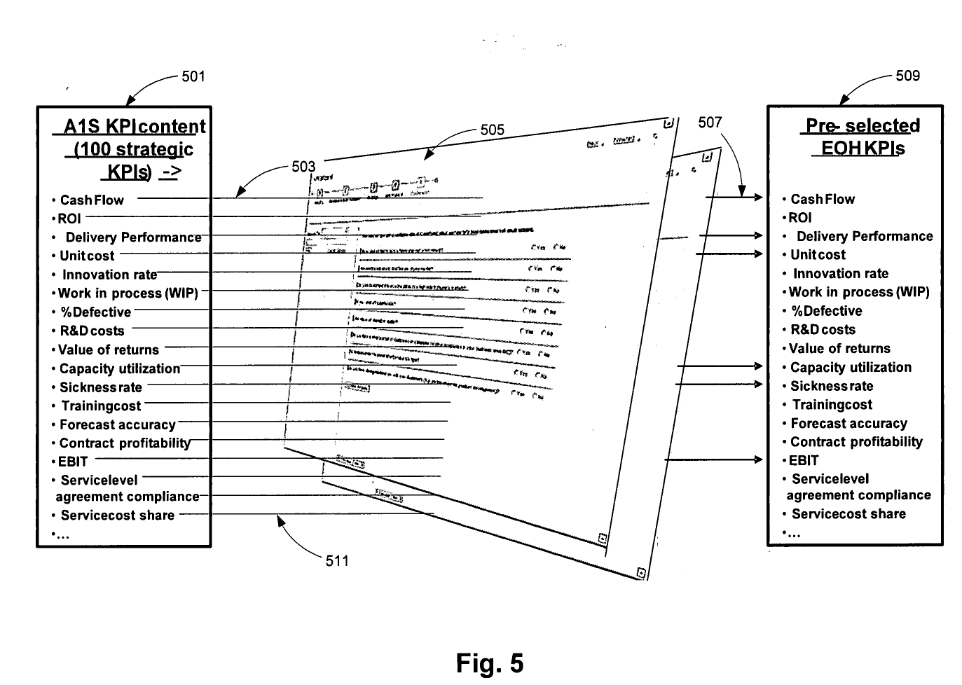

FIG. 5A is a block diagram illustrating one embodiment of a system for selecting key performance indicators for accessing enterprise operation health. A key performance indicator may be related to a business attribute. The KPI (key performance indicator), is a measurement for evaluating a company's business strategy, performance, and/or technology. This can be used to compare results and measure the company's performance according to known benchmarking criteria.

For example, KPI mapping in a data collector can provide at least the following key functionalities:
Mapping EOH KPIs with business application's built-in KPIs
Customize own EOH KPI
Hierarchical EOH KPI structures
Predefined EOH KPI structures based on the existing ERP system
Configuration functionality
Fine tuning for the mapping

In one embodiment, 100 strategic key performance indicators in KPIcontent 501 from an ERP system are pre-selected into a set of KPIs' in Pre-selected EOHKPIs 509 via a user interface 505. For example, CashFlow indicator 503 from an ERP system is selected into the corresponding CashFlow indicator 507. In one embodiment, the Servicecost share indicator 511 is filtered away via the configuration user interface 505.

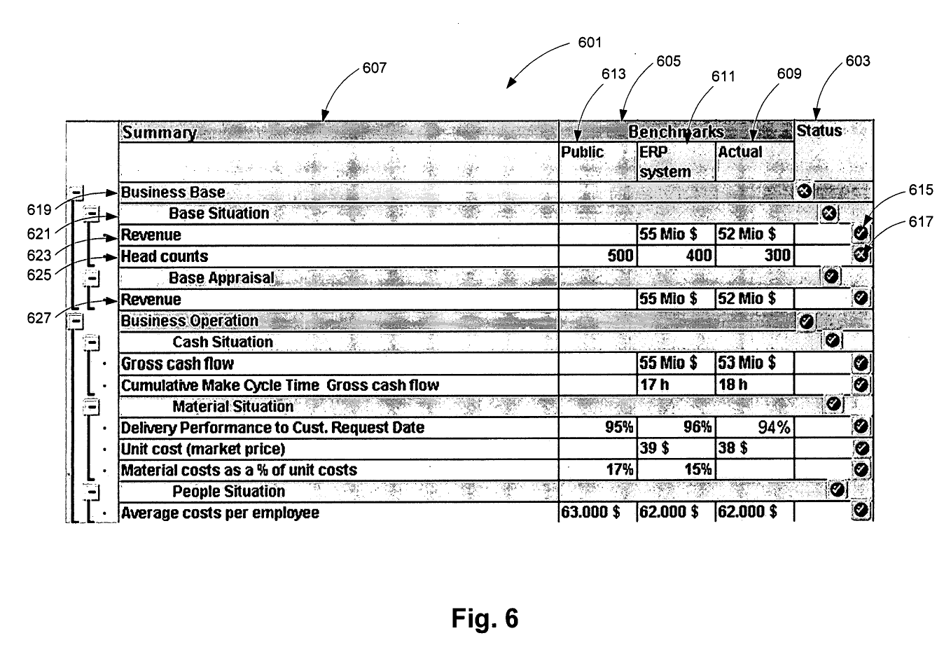

FIG. 6 is an example of a user interface illustrating a credit report according to one embodiment of accessing enterprise operation health. A credit report may be organized in a hierarchy according to categories and groups of business attributes. In one embodiment, a credit report includes a Summary column 607 corresponding to business attributes such as Revenue 623 and Headcount 625 grouped under business attribute group Base Situation 621 in a business category Business Base 619. In one embodiment, the hierarchical organization in a credit report is arranged based on the hierarchical structure in the associated business attributes such as in the EHA Predefined Category 103 of FIG. 1.

In one embodiment, the credit report 601 includes a Benchmarks column 605 presenting a comparison between credit related business information and its corresponding references. A business attribute may have a reference value listed under Public column 613 based on a published data source about the underlying industry of the relevant business. A business attribute may have a reference value listed under ERP system column 611 to display a benchmark value stored in the EIS system. An ERP system benchmark value may be configured as a part of enterprise health assessment structure 407 of FIG. 4. The current value of a business attribute according to an EIS, such as the applications 303 in FIG. 3, may be listed under the Actual column 609. In one embodiment, the status values corresponding to a business attribute. A group of business attributes or a category of business attributes are listed under status column 603. A status of a business attribute may be satisfactory as a result of comparison with benchmark references when indicated by a check mark 615. An unsatisfactory status may be indicated by a cross mark 617. In one embodiment, a predefined percentage margin, such a 5%, is included in the benchmark comparison to determine a status value of a business attribute. Note that the GUI as shown in FIG. 6 is described for illustration purposes only. Other formats or layouts may be implemented.

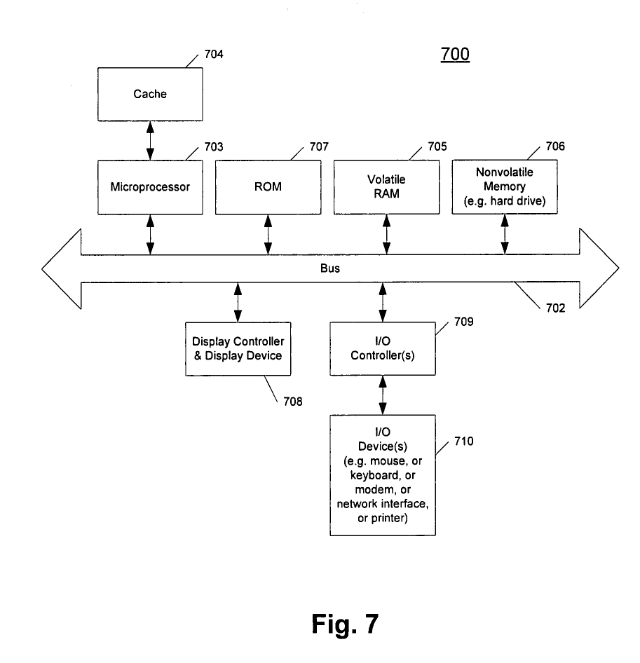

FIG. 7 shows one example of a computer system 701 which may be used to implement an embodiment of the present invention. For example, system 701 may be used to implement at least part of systems as shown in FIGS. 1 and 3-4 as described above. Note that while FIG. 7 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 7, the computer system 701, which is a type of a data processing system, includes a bus 703 which is coupled to a microprocessor(s) 705 and a ROM (Read Only Memory) 707 and volatile RAM 709 and a non-volatile memory 1211. The microprocessor 703 may retrieve the instructions from the memories 707 709 711 and execute the instructions to perform operations described above. The bus 703 interconnects these various components together and also interconnects these components 705, 707, 709, and 711 to a display controller and display device 713 and to peripheral devices such as input/output (I/O) devices which may be mice, keyboards, modems, network interfaces, printers and other devices which are well known in the art. Typically, the input/output devices 715 are coupled to the system through input/output controllers 717. The volatile RAM (Random Access Memory) 709 is typically implemented as dynamic RAM (DRAM) which requires power continually in order to refresh or maintain the data in the memory.

The mass storage 711 is typically a magnetic hard drive or a magnetic optical drive or an optical drive or a DVD RAM or other types of memory systems which maintain data (e.g. large amounts of data) even after power is removed from the system. Typically, the mass storage 711 will also be a random access memory although this is not required. While FIG. 7 shows that the mass storage 711 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 703 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, ABAP, Fortran, Pascal, Perl, etc.) supported by various software development frameworks (e.g., SAP Netweaver, SAP ABAP Workbench, Microsoft Corporation's NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In addition, the operations described above may be performed by an apparatus. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not specifically related to a particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the scope of the invention

What is claimed is:

1. A machine-implemented method, comprising:
in response to a query for an enterprise operation health (EOH) assessment of an organization over a network, dynamically accessing an enterprise information system (EIS) associated with the organization to retrieve business transaction information during course of operations within the organization; and
automatically generating an EOH report based on the retrieved business transaction information associated with the organization according to one or more requirements of the EOH report.

2. The method of claim 1, further comprising extracting at least a portion of the business transaction information from the EIS, wherein the EOH report is generated based on the extracted business transaction information.

3. The method of claim 2, wherein the EOH report is generated based on a report template specifying one or more business transaction categories in which the at least portion of the business transaction information is extracted from the EIS.

4. The method of claim 3, further comprising maintaining key performance index (KPI) mapping between the EIS and the one or more business transaction categories of the report template, wherein the business transaction information is extracted via the KPI mapping in view of the EIS and the report template.

5. The method of claim 4, wherein the one or more categories of the report template is user definable dependent upon a format of the EOH report.

6. The method of claim 4, further comprising collecting data representing the business transaction information via the KPI mapping based on the one or more business transaction categories of the report template during the course of the operations of organization.

7. The method of claim 6, further comprising generating an advisory statement based on the EOH report, the advisory statement suggesting one or more future actions to be performed in view of one or more categories of the EOH report.

8. The method of claim 7, wherein the advisory statement is generated based on one or more rules with respect to the one or more categories of the EOH report, the one or more rules including one or more thresholds definable by a user.

9. A machine-readable medium having instructions therein, which when executed by a machine, cause the machine to perform a method, the method comprising:
in response to a query for an enterprise operation health (EOH) assessment of an organization over a network, dynamically accessing an enterprise information system (EIS) associated with the organization to retrieve business transaction information during course of operations within the organization; and
automatically generating an EOH report based on the retrieved business transaction information associated with the organization according to one or more requirements of the EOH report.

10. The machine-readable medium of claim 9, wherein the method further comprises extracting at least a portion of the business transaction information from the EIS, wherein the EOH report is generated based on the extracted business transaction information.

11. The machine-readable medium of claim 10, wherein the EOH report is generated based on a report template specifying one or more business transaction categories in which the at least portion of the business transaction information is extracted from the EIS.

12. The machine-readable medium of claim 11, wherein the method further comprises maintaining key performance index (KPI) mapping between the EIS and the one or more business transaction categories of the report template, wherein the business transaction information is extracted via the KPI mapping in view of the EIS and the report template.

13. The machine-readable medium of claim 12, wherein the one or more categories of the report template is user definable dependent upon a format of the EOH report.

14. The machine-readable medium of claim 12, wherein the method further comprises collecting data representing the business transaction information via the KPI mapping based on the one or more business transaction categories of the report template during the course of the operations of organization.

15. The machine-readable medium of claim 14, wherein the method further comprises generating an advisory statement based on the EOH report, the advisory statement suggesting one or more future actions to be performed in view of one or more categories of the EOH report.

16. The machine-readable medium of claim 15, wherein the advisory statement is generated based on one or more rules with respect to the one or more categories of the EOH report, the one or more rules including one or more thresholds definable by a user.

17. A data processing system, comprising:
processing logic, in response to a query for an enterprise operation health (EOH) assessment of an organization over a network, to dynamically access an enterprise information system (EIS) associated with the organization to retrieve business transaction information during course of operations within the organization; and
a report generator coupled to the processing logic to automatically generate an EOH report based on the retrieved business transaction information associated with the organization according to one or more requirements of the EOH report.

18. The system of claim 17, further comprising a KPI (key performance index) mapping unit to extract at least a portion of the business transaction information from the EIS, wherein the EOH report is generated based on the extracted business transaction information.

19. The system of claim 18, further comprising a data collection unit coupled to the KPI mapping unit to collect data representing the business transaction information via the KPI mapping based on the one or more business transaction categories during the course of the operations of organization.

20. The system of claim 19, further comprising an advisory unit coupled to the report generator to generate an advisory statement based on the EOH report, the advisory statement suggesting one or more future actions to be performed in view of one or more categories of the EOH report.
